(19) United States
(12) Patent Application Publication
(10) Pub. No.: US 2026/0141460 A1
(43) Pub. Date: May 21, 2026

(54) CLAIM ADJUSTMENT SYSTEM

(71) Applicant: Charles Nelson, Midland, TX (US)

(72) Inventor: Charles Nelson, Midland, TX (US)

(21) Appl. No.: 19/390,245

(22) Filed: Nov. 14, 2025

Related U.S. Application Data
(60) Provisional application No. 63/721,237, filed on Nov. 15, 2024.

(51) Int. Cl. G06Q 40/08

(52) U.S. Cl. CPC G06Q 40/084

(57) ABSTRACT

Apparatus and associated methods relate to a claim adjustment process management system (CAPMS) including a coverage comparison engine configured to generate a coverage analysis object (CAO) and a reference model interpretation engine configured to generate an initial coverage determination (ICD). For example, the CAPMS may receive claim object, a reference model, and a claim adjustment input (CAI). The reference model interpretation engine may, for example, apply a natural language processing (NLP) model to process claim object and the reference model to generate the ICD. The coverage comparison engine may, for example, analyze the ICD and the CAI to identify variances between the two and generate the CAO. The CAO may, for example, include an error and omission signal. The CAO may, for example, include a resolution object. Various embodiments may advantageously automate claim adjustment processes and reduce human error and ensure consistent, fair coverage determinations.

### CROSS-REFERENCE TO RELATED APPLICATIONS

This application is a non-provisional application and claims the benefit of U.S. Application Ser. No. 63/721,237, titled “Digital Adjusting System,” filed by Charles Nelson on Nov. 15, 2024.

This application incorporates the entire contents of the foregoing application(s) herein by reference.

### TECHNICAL FIELD

Various embodiments relate generally to natural language processing systems.

### BACKGROUND

Natural Language Processing (NLP) is a field within artificial intelligence focused on enabling computers to understand, interpret, and generate human language. By combining linguistic knowledge with machine learning, for example, NLP may allow systems to process and analyze text and/or speech data in a way that mimics human understanding. Applications of NLP include language translation, sentiment analysis, chatbots, text summarization, and/or automated customer support.

In document analysis, NLP techniques may be widely used to extract and interpret information from raw input text. For example, NLP may parse one or more documents to identify clauses, terms, and key data points like names, dates, and conditions. For example, Named Entity Recognition (NER) may allow systems to identify specific information such as policyholder names or contract numbers. For example, sentiment analysis helps detect positive or negative tones in customer feedback. NLP models, for example, including transformer-based models like Bidirectional Encoder Representations from Transformers (BERT) and/or generative Pre-trained Transformer (GPT), have significantly improved the accuracy and depth of document analysis.

### SUMMARY

Apparatus and associated methods relate to a claim adjustment process management system (CAPMS) including a coverage comparison engine configured to generate a coverage analysis object (CAO) and a reference model interpretation engine configured to generate an initial coverage determination (ICD). For example, the CAPMS may receive claim object, a reference model, and a claim adjustment input (CAI). The reference model interpretation engine may, for example, apply a natural language processing (NLP) model to process claim object and the reference model to generate the ICD. The coverage comparison engine may, for example, analyze the ICD and the CAI to identify variances between the two and generate the CAO. The CAO may, for example, include an error and omission signal. The CAO may, for example, include a resolution object. Various embodiments may advantageously automate claim adjustment processes and reduce human error and ensure consistent, fair coverage determinations.

Various embodiments may achieve one or more advantages. For example, some embodiments may improve claim adjustment accuracy and efficiency. In some implementations a CAPMS may, for example, advantageously reduce human error. In some embodiments a CAPMS may, for example, advantageously ensure consistent and fair outcomes. In some implementations a CAPMS may, for example, advantageously accelerate resolution of claim disputes. In some embodiments a CAPMS may, for example, advantageously enhance transparency and trust in the claims process.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary claim adjustment process management system (CAPMS) employed in an illustrative use-case scenario.

FIG. 2 is a block diagram depicting an exemplary CAPMS.

FIG. 3 is a flowchart illustrating an exemplary reference model interpretation error identification method.

FIG. 4 is a flowchart illustrating an exemplary claim adjustment process management method.

Like reference symbols in the various drawings indicate like elements.

### DETAILED DESCRIPTION OF ILLUSTRATIVE EMBODIMENTS

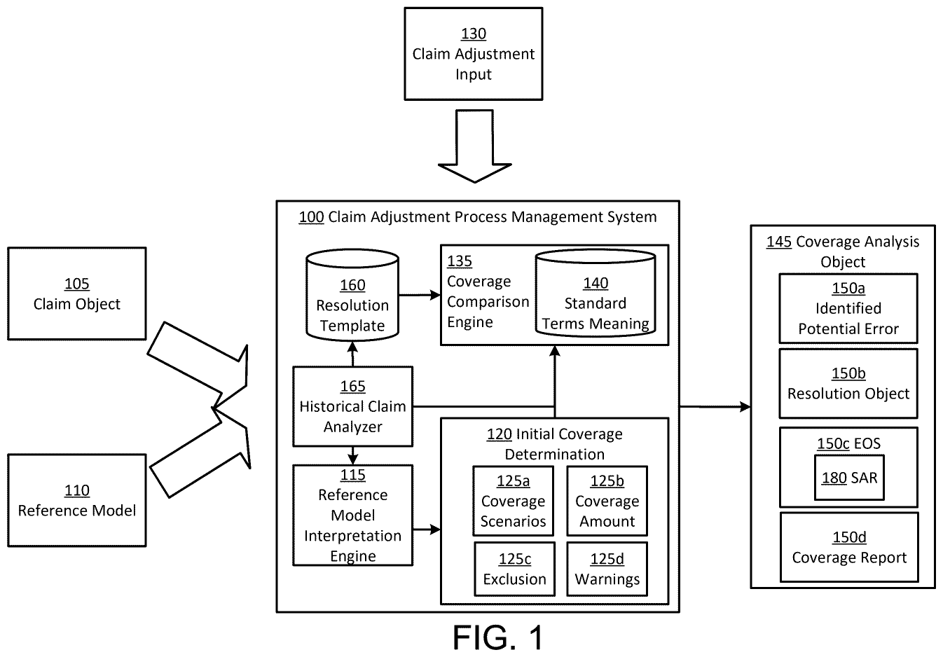

FIG. 1 depicts an exemplary claim adjustment process management system (CAPMS 100) employed in an illustrative use-case scenario. For example, the CAPMS 100 may be implemented as a web application accessible through the Internet. For example, the CAPMS 100 may be installed in a computer device (e.g., a desktop computer, a laptop computer, a mobile device).

In this example, the CAPMS 100 receives a claim object 105 and a reference model 110. In some implementations, the claim object 105 and the reference model 110 may be uploaded by a user of the CAPMS 100. For example, the user may include a homeowner. For example, the user may include a car owner. For example, the user may include a medical professional.

For example, the claim object 105 may include a claim record. For example, the claim object 105 may include a description of an incident. For example, the claim object 105 may include images of the incident. For example, the claim object 105 may include a form having data related to the incident. In some implementations, the claim object 105 may include a description of a situation and/or claim details via text (e.g., input via a type note, a dictated note by voice, a video). For example, the reference model 110 may include insurance policies, contracts, or any related paperwork in various formats (PDF, DOCX, images, etc.).

As shown, the CAPMS 100 includes a reference model interpretation engine 115. For example, the reference model interpretation engine 115 may apply a natural language processing (NLP) model to process the claim object 105 and the reference model 110. For example, the reference model interpretation engine 115 may identify information from the reference model 110 including, for example, identifiers such as a policyholder name, an insurance policy number, a time period of coverage, or a combination thereof.

In some examples, the reference model interpretation engine 115 may identify a type of the reference model 110. The reference model 110 may, for example, include an insurance policy. For example, the reference model interpretation engine 115 may determine that the reference model 110 is a homeowner policy. For example, the reference model interpretation engine 115 may determine that the reference model 110 is a car owner. In some implementations, based on the reference model type, the reference model interpretation engine 115 may identify information. For example, when the reference model 110 is a homeowner reference model or a car owner policy, the reference model interpretation engine 115 may determine covered perils in the reference model 110. For example, when the reference model 110 is a health policy, the reference model interpretation engine 115 may identify covered medical procedures and/or coverage limits (e.g., for one or more of the medical procedures).

In some implementations, the reference model interpretation engine 115 may determine various terms in the reference model 110. For example, the reference model interpretation engine 115 may determine deductibles, exclusions, and/or conditions in the reference model 110.

Based on languages in the reference model 110, for example, the reference model interpretation engine 115 may generate an initial coverage determination (ICD 120). In some implementations, the reference model interpretation engine 115 may cross-reference extracted data with reference model language to generate the ICD 120. In this example, the ICD 120 includes a coverage scenarios 125a, a coverage amount 125b, an exclusion 125c, and warnings 125d. For example, the exclusion 125c may include exclusions or conditions tied to the coverage.

For example, the coverage scenarios 125a may be generated based on incident details included in the claim object 105. For example, the coverage amount 125b may be estimated based on the coverage scenarios 125a and the reference model 110. The exclusion 125c, for example, may include relevant exclusions or limitations in the reference model 110 associated with the coverage scenarios 125a. The warnings 125d may, for example, flag parameter sets (e.g., provisions with ambiguous or complex wording, provisions using “term of art”) that may lead to resolutions in coverage determination (e.g., “wear and tear” exclusions or “acts of God”). Resolutions may, for example, include resolving disputes.

In this example, the CAPMS 100 receives a claim adjustment input (CAI 130). For example, the CAI 130 may be generated by an external party (e.g., an insurance company, a claim adjuster). In some implementations, the CAPMS 100 may perform a human review variance check based on the CAI 130 and the ICD 120. As shown, the CAPMS 100 includes a coverage comparison engine (CCE 135). For example, the CCE 135 may find variances between the CAI 130 and the coverage amount 125b. For example, the CCE 135 may automatically compare the CAI 130 with standard industry coverage for similar claims based on a standard terms meaning database 140. For example, the database 140 may be predefined by experts in the reference model 110. For example, the database 140 may be updated periodically to maintain updated information. In some examples, the CCE 135 may access the database 140 based on information identified in the reference model 110. For example, some interpretations may be specific to location of the incident, the policyholder, the policy provider, and/or an execution of the reference model 110. In some implementations, the CCE 135 may generate a coverage analysis object (145) based on the comparison. For example, the CAO 145 may be transmitted to the user for further action.

As shown, the CAO 145 includes identified potential errors (IPE 150a) and a resolution object 150b. For example, the IPE 150a may include potential errors in the CAI 130. For example, the IPE 150a may include incorrect interpretation of policy clauses. For example, the IPE 150a may include overlooked coverage and/or exclusions. For example, the IPE 150a may include misclassification of event or incident in the claim object 105.

As shown, the CAPMS 100 includes a resolution template datastore 160. In some implementations, the CCE 135 may initiate an automatic resolution sequence when an error is determined in the CAI 130. For example, the CAO 145 may include an EOS 150c to the user. For example, the EOS 150c may include an explanation of a detected variance and/or a detailed report of why the ICD 120 may be incorrect. For example, the user may decide whether to accept the variance based on the EOS 150c. If, for example, the user decides to accept the result, the user may use the resolution object 150b. For example, the CCE 135 may generate the resolution object 150b to include resolution templates (e.g., generated from the resolution template datastore 160) for communicating with the external party (e.g., the insurance company). For example, the resolution template may include predefined instruction sets. For example, the predefined instruction sets may include suggested language to communicate the IPE 150a to the insurance company for a quick resolution of a dispute.

As shown, the CAO 145 includes a coverage report 150d. For example, the coverage report 150d may include a detailed breakdown of covered elements. For example, the coverage report 150d may include excluded portions of the claim. For example, the coverage report 150d may include suggested next steps for maximizing coverage.

In some implementations, the coverage report 150d may include pre-filled claim forms. For example, the pre-filled claim forms may include information identified by the reference model interpretation engine 115. For example, the pre-filled claim form may include details aligning with the reference model 110. Various embodiments may advantageously provide a seamless fling process for the user with the insurance provider.

In some implementations, the CAPMS 100 may identify potential errors in claim adjustments by leveraging historical data from similar claims to ensure consistent application of reference model language. For example, some claim adjustment processes may be complex and require careful alignment with historical precedent and/or reference model language consistency. In some examples, errors in a claims process may occur due to human oversight. In some examples, some errors may be due to an intentional exclusion of reference model items previously been approved in similar circumstances.

In this example, the CAPMS 100 includes a historical claim analyzer (HCA 165). For example, the HCA 165 may access historical data from past claims and/or historical policies to cross-check current claim interpretations. Various embodiments may advantageously improve accuracy, prevent variances, and/or ensure fair treatment across claims with similar conditions.

In some implementations, the HCA 165 may store historical claim data (e.g., policy language, coverage items, previous claim decisions). For example, the historical claim data may be retrieved from similar claims received from the users of the CAPMS 100 under comparable policies. For example, the HCA 165 may classify the historical claim data into same or similar carriers (e.g., the insurance companies).

As shown, the HCA 165 is operably coupled to the CCE 135. In some implementations, the HCA 165 may perform a similarity-based error detection (SBED) with the CCE 135. For example, the HCA 165 may cross-reference incoming claims (e.g., the claim object 105) with the stored historical claim data. For example, the HCA 165 may determine whether relevant items covered in past claims are also included in the current claim. This comparison criteria, for example, may include reference model type, coverage details, carrier-specific language, policyholder characteristics, or a combination thereof.

If the CCE 135, through the SBED, identifies that a current claim lacks items that were previously approved under similar conditions, for example, may include the identified information into the EOS 150c. For example, the EOS 150c may notify the user of potentially missing items and/or overlooked coverage.

Various embodiments may advantageously provide a consistent, reliable approach to identify variances in claim processing due to error or oversight. By analyzing historical data, for example, the HCA 165 may advantageously ensure that reference model terms are applied fairly across similar claims. For example, the EOS 150c may advantageously prevent unintended exclusions. Some embodiments may advantageously enhance trust in the claims process.

In some implementations, as shown in FIG. 1, when a variance is detected, the CAPMS 100 may generate the EOS 150c including a similarity analysis report (SAR 180). For example, the SAR 180 may include details of items omitted. For example, the SAR 180 may include, for the omitted items, a relevance of the corresponding item based on past approvals in similar claims. The SAR 180 may, in some examples, include recommendation on whether the variance warrants further review or immediate resolution.

In some implementations, the CCE 135 may include, in the EOS 150c, a distinction between errors likely due to human oversight and those that may suggest intentional exclusion. For example, the CCE 135 may determine the distinction based on frequency analysis of similar errors across claims handled by the same adjuster or carrier. For example, the EOS 150c may signal users to possible malicious or negligent behavior if unusual exclusion patterns are detected.

In various examples, the reference model interpretation engine 115 may include an NLP-driven engine configured to extract and interpret reference model language. For example, the CCE 135 may advantageously identify human errors in reference model interpretation. For example, the CCE 135 may advantageously provide a user-friendly resolution process (e.g., by providing automated resolution creation).

In various implementations, a CAPMS (e.g., the CAPMS 100) may generate a recommendation to reference model holders for arguing coverage by interpreting and identifying proper parameter sets in a reference model (e.g., the reference model 110). For example, the parameter sets in a reference model may include the provisions in a policy. In some examples, the CAPMS may automatically generate a claim adjustment process and strategy automatically without human intervention.

In some implementations, one or more state model vectors may be substantially similar to the initial coverage determination 120. For example, the one or more state model vectors may represent a structured computational output that models the CAPMS 100 preliminary assessment of claim-related data. One or more input parameter vectors may be substantially similar to the claim adjustment inputs 130. For example, the one or more input parameter vectors may function as structured representations of external or user-provided adjustment data that are processed by the CAPMS 100. One or more resolution sequences may be substantially similar to the coverage analysis object 145. For example, the one or more resolution sequences may serve as a generated output that encapsulate the system's analysis of variances, potential errors, and recommended resolution actions.

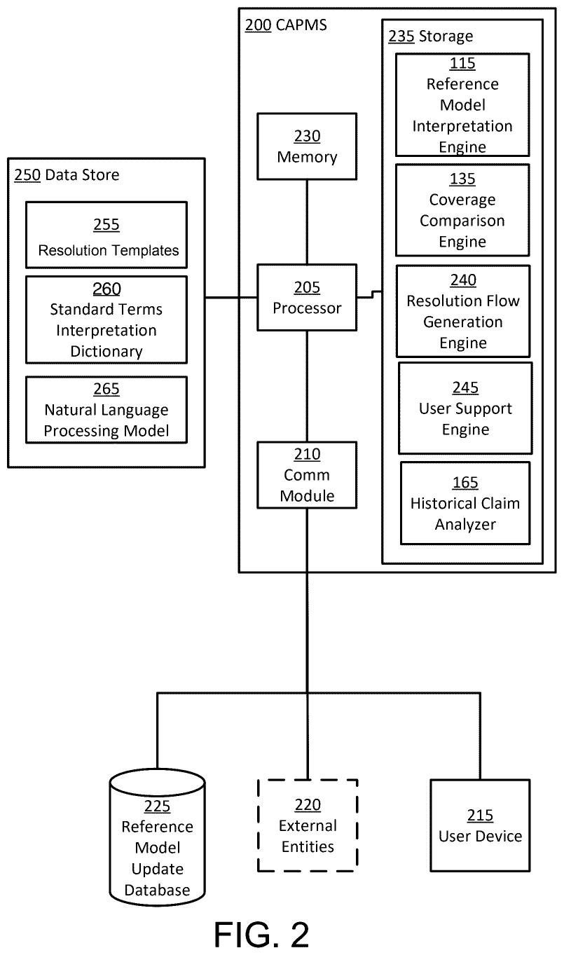

FIG. 2 is a block diagram depicting an exemplary CAPMS 200. For example, the CAPMS 200 may be the CAPMS 100 as described with reference to FIG. 1. The exemplary CAPMS 200 includes a processor 205. The processor 205 may, for example, include one or more processing units. The processor 205 is operably coupled to a communication module 210. The communication module 210 may, for example, include wired communication. The communication module 210 may, for example, include wireless communication. In the depicted example, the communication module 210 is operably coupled to a user device 215, external entities 220, and a reference model update database 225. For example, a user may upload the claim object 105 and/or the reference model 110 to the exemplary CAPMS 200 using the user device 215. In some implementations, the user may input the CAI 130 to the exemplary CAPMS 200 using the user device 215.

The external entities 220, for example, may be coupled to the communication module 210 in some embodiments. For example, the exemplary CAPMS 200 may be configured to communicate directly with the external entities 220 (e.g., an insurance company, a claim adjusting agent) to receive the CAI 130. For example, the exemplary CAPMS 200 may be configured to follow up with the external entities 220 (e.g., by transmitting messages to the external entities 220 directly). The reference model update database 225, for example, may include updated interpretation, terms, provisions, and/or clauses of the reference model 110.

The processor 205 is operably coupled to a memory module 230. The memory module 230 may, for example, include one or more memory modules (e.g., random-access memory (RAM)). The processor 205 includes a storage module 235. The storage module 235 may, for example, include one or more storage modules (e.g., non-volatile memory). In the depicted example, the storage module 235 includes the reference model interpretation engine 115 and the CCE 135. As shown, the storage module 235 includes a resolution flow generation engine (RFGE 240) and a user support engine 245.

For example, the RFGE 240 may be invoked by the CCE 135 when a variance is identified between the ICD 120 and the CAI 130. For example, the RFGE 240 may generate a resolution flow for the user using the resolution template datastore 160. The user support engine 245, for example, may monitor for responses from the external entities 220 (e.g., the insurance company) after a claim has been filed. For example, the user support engine 245 may signal users to any potential denial or variances received from the external entities 220. In some implementations, the user support engine 245 may automatically check for further human errors in reference model interpretation during a resolution and/or claiming process. In some implementations, the user support engine 245 may generate the additional resolution actions and/or resolution approaches (e.g., by generating the CAO 145 to the user device 215).

In some implementations, the user support engine 245 may transmit a reminder to the user device 215 when a coverage period is below a predetermined threshold (e.g., is about to expire). In some implementations, the user support engine 245 may notify the user when particular changes in reference model language are detected.

The processor 205 is further operably coupled to a data store 250. The data store 250 includes resolution templates 255, a standard terms interpretation dictionary 260, and a natural language processing model (NLP model 265). For example, the resolution templates 255 may be stored in the resolution template datastore 160. For example, the RFGE 240 may generate the resolution object 150b based on the resolution templates 255. For example, the reference model interpretation engine 115 may generate the ICD 120 as a function of the standard terms interpretation dictionary 260 and the resolution templates 255.

For example, the reference model interpretation engine 115 may update (e.g., periodically, in real-time) the standard terms interpretation dictionary 260. The standard terms dictionary 260 may, for example, be substantially similar to the database 140. In some implementations, the reference model interpretation engine 115 may be configured to track reference model updates (e.g., and/or changes) in the reference model update database 225. For example, the updated reference model may affect future claims (e.g., having new exclusions and/or modified coverage).

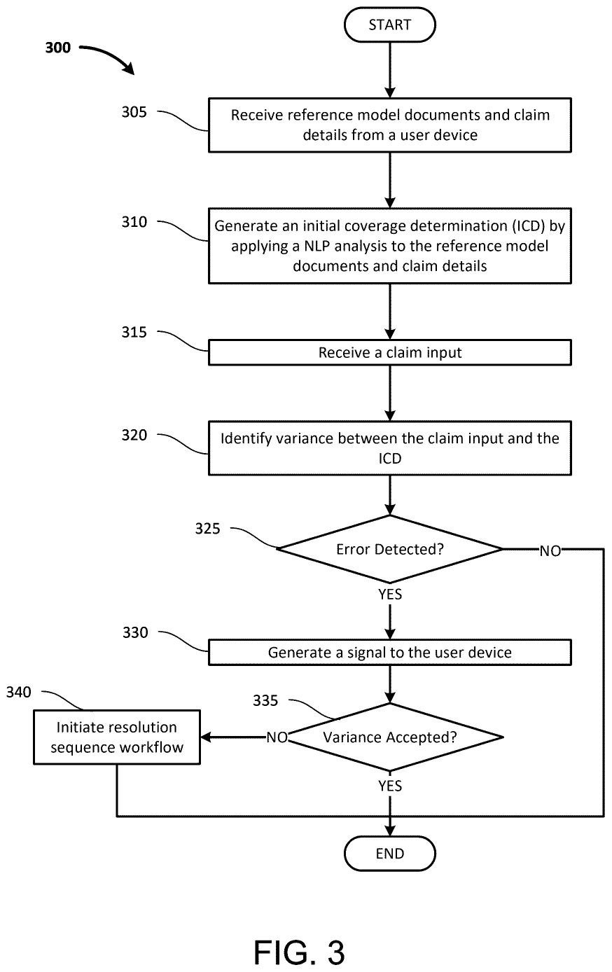

FIG. 3 is a flowchart illustrating an exemplary reference model interpretation error identification method 300. For example, the method 300 may be performed by the reference model interpretation engine 115. In this example, the method 300 begins in step 305 when reference model documents and claim details are received from a user device. For example, the reference model interpretation engine 115 may receive a claim object 105 and a reference model 110 uploaded by the user via the CAPMS 100.

In step 310, an initial coverage determination (ICD) is generated by applying an NLP analysis to the reference model documents and claim details. For example, the reference model interpretation engine 115 may analyze the reference model 110 and the claim object 105 to generate the ICD 120 (e.g., identifying coverage scenarios, exclusions, and/or estimated coverage amounts). In some examples, when a new claim is submitted, the HCA 165 may retrieve comparable claim data and reference model language from past claims with similar parameters. For example, the CAPMS 100 may apply an NLP-based pattern recognition to detect any missing items that have historically been covered. The CCE 135 then compares these findings to the claim input, flagging any variances.

In step 315, a claim input is received. For example, the CAPMS 100 may receive a claim adjustment input (CAI 130) generated by an external party (e.g., the external entities 220, an insurance company, a claim adjuster). For example, the CAI 130 may include a human interpretation of the coverage (e.g., against a claim).

After receiving the claim input, one or more variances between the claim input and the ICD is identified in step 320. For example, the coverage comparison engine (CCE 135) may compare the CAI 130 with the ICD 120, checking for differences in interpretation.

At a decision point 325, it is determined whether an error is detected based on the variance. For example, the CCE 135 may determine whether the CAI 130 includes potential errors. For example, the IPE 150a may include incorrect interpretation of reference model clauses, overlooked exclusions, and/or other errors.

If no error is detected, the method 300 ends. If an error is detected, in step 330, a signal is generated and sent to the user device. For example, the CAPMS 100 may transmit an error and omission signal (EOS 150c) to the user, detailing the detected variance and the reasons why the initial determination may be incorrect.

At a decision point 335, it is determined whether the variance is accepted by the user. For example, the user may decide to accept the variance (e.g., do not resolution the determination) after receiving the CAO 145.

If the variance is accepted, the method 300 ends. If the variance is not accepted, in step 340, a resolution sequence is initiated, and the method 300 ends. For example, the resolution flow generation engine (RFGE 240) may generate a resolution object 150b, including resolution templates from the resolution template datastore 160.

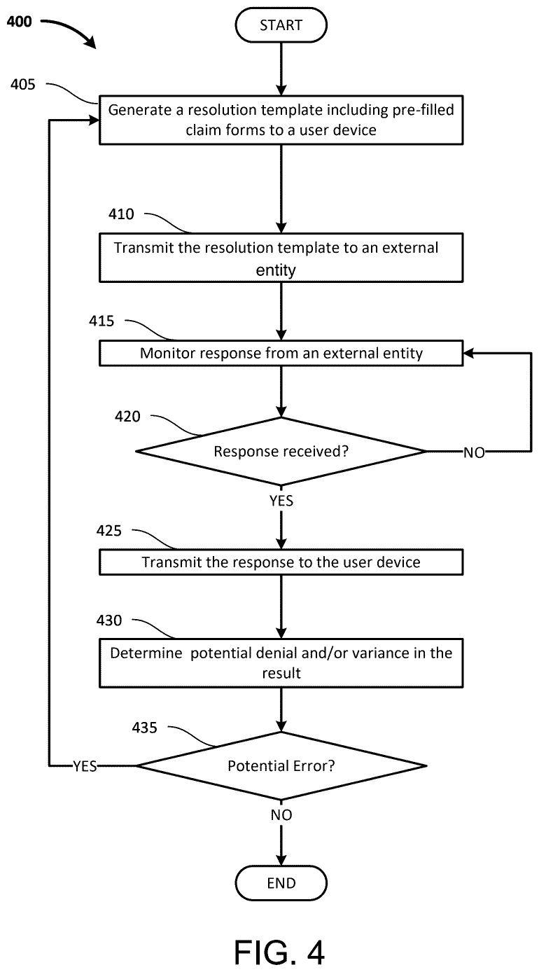

FIG. 4 is a flowchart illustrating an exemplary claim adjustment process management method 400. For example, the method 400 may be performed by the CCE 135. In this example, the method 400 begins when a resolution template is generated including pre-filled claim forms to a user device in step 405. For example, the RFGE 240 may generate a resolution object 150b containing the pre-filled forms from the resolution template datastore 160 and transmit it to the user device 215.

In step 410, the resolution form is transmitted to an external entity. For example, the RFGE 240 may send a resolution form to the external entities 220 (e.g., the insurance company) pre-filled with information identified by the reference model interpretation engine 115 through the communication module 210.

In step 415, a response from the external entity is monitored. For example, the user support engine 245 may track the incoming messages from the insurance company to identify a response. At a decision point 420, it is determined whether a response has been received. For example, the user support engine 245 may check for new correspondence from the insurance company. If no response is received, the step 415 is repeated.

If a response is received, in step 425, the response is transmitted to the user device. For example, the user support engine 245 may forward the insurance company's response to the user device 215 for review. After the response is received, potential denial and/or variances in the response are determined in step 430. For example, the user support engine 245 may apply the NLP model 265 to analyze the response to identify any denial or variances in the coverage decision.

At a decision point 435, it is determined whether a potential error is identified. For example, the user support engine 245 may detect inconsistencies or errors based on the identified variances. If a potential error is detected, the step 405 is repeated. For example, a new resolution template is generated to the user device 215 for further action.

Although various embodiments have been described with reference to the figures, other embodiments are possible. For example, the reference model interpretation engine 115 and the CCE 135 may be embodied in separate systems. For example, a first system may be configured to generate the ICD 120. For example, a second system may be configured to receive the ICD 120 or a human input as initial interpretation of the reference model 110 and/or the claim object 105.

Although an exemplary system has been described with reference to FIG. 1, other implementations may be deployed in other industrial, scientific, medical, commercial, and/or residential applications. In some implementations, the CAPMS 100 may support multiple sectors. For example, the database 140 may include interpretation based on an identified sector (e.g., homeowners, car owners, medical professionals). In some implementations, the user support engine 245 may be configured to offer custom reports based on industry needs.

For example, the CAPMS 100 may integrate with third-party measurement and assessment software (e.g., including but not limited to property, medical, and/or other insurance domains). For example, the CAPMS 100 may accept measurement data from third-party software for property claims. For example, the third party software may provide detailed property measurements that is relevant to property insurance coverage decisions. For example, for medical and/or other specialized claims, the CAPMS 100 may be connected with relevant third-party sources to acquire data for coverage and claim determination.

In some embodiments, the CAPMS 100 may include a data integration module (DIM) configured to access, store, and/or process data received from external sources (e.g., the relevant third-party software). The DIM may be coupled to the CCE 135 and the HCA 165, in some implementations. For example, the DIM may verify whether claims align with reference model terms and flag variances if data provided by the external sources reveals any inconsistency in coverage determinations.

By including third-party data in claims analysis, for example, the CAPMS 100 may advantageously enhance its ability to cross-check data (e.g., measurements, medical assessments, and/or other inputs) against historical claim data, reference model language, and standard terms.

In various embodiments, some bypass circuits implementations may be controlled in response to signals from analog or digital components, which may be discrete, integrated, or a combination of each. Some embodiments may include programmed, programmable devices, or some combination thereof (e.g., PLAs, PLDs, ASICs, microcontroller, microprocessor), and may include one or more data stores (e.g., cell, register, block, page) that provide single or multi-level digital data storage capability, and which may be volatile, non-volatile, or some combination thereof. Some control functions may be implemented in hardware, software, firmware, or a combination of any of them.

Computer program products may contain a set of instructions that, when executed by a processor device, cause the processor to perform prescribed functions. These functions may be performed in conjunction with controlled devices in operable communication with the processor. Computer program products, which may include software, may be stored in a data store tangibly embedded on a storage medium, such as an electronic, magnetic, or rotating storage device, and may be fixed or removable (e.g., hard disk, floppy disk, thumb drive, CD, DVD).

Although an example of a system, which may be portable, has been described with reference to the above figures, other implementations may be deployed in other processing applications, such as desktop and networked environments.

Temporary auxiliary energy inputs may be received, for example, from chargeable or single use batteries, which may enable use in portable or remote applications. Some embodiments may operate with other DC voltage sources, such as 9V (nominal) batteries, for example. Alternating current (AC) inputs, which may be provided, for example from a 50/60 Hz power port, or from a portable electric generator, may be received via a rectifier and appropriate scaling. Provision for AC (e.g., sine wave, square wave, triangular wave) inputs may include a line frequency transformer to provide voltage step-up, voltage step-down, and/or isolation.

Although particular features of an architecture have been described, other features may be incorporated to improve performance. For example, caching (e.g., L1, L2, . . . ) techniques may be used. Random access memory may be included, for example, to provide scratch pad memory and or to load executable code or parameter information stored for use during runtime operations. Other hardware and software may be provided to perform operations, such as network or other communications using one or more protocols, wireless (e.g., infrared) communications, stored operational energy and power supplies (e.g., batteries), switching and/or linear power supply circuits, software maintenance (e.g., self-test, upgrades), and the like. One or more communication interfaces may be provided in support of data storage and related operations.

Some systems may be implemented as a computer system that can be used with various implementations. For example, various implementations may include digital circuitry, analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Various embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and CD-ROM and DVD-ROM disks. The processor and the memory can be supplemented by, or incorporated in, ASICs (application-specific integrated circuits).

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. Various embodiments may be implemented in a computer system that includes a graphical user interface and/or an Internet browser. To provide for interaction with a user, some implementations may be implemented on a computer having a display device. The display device may, for example, include an LED (light-emitting diode) display. In some implementations, a display device may, for example, include a CRT (cathode ray tube). In some implementations, a display device may include, for example, an LCD (liquid crystal display). A display device (e.g., monitor) may, for example, be used for displaying information to the user. Some implementations may, for example, include a keyboard and/or pointing device (e.g., mouse, trackpad, trackball, joystick), such as by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, the computers and networks forming the Internet, or some combination thereof. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, multiplexing techniques based on frequency, time, or code division, or some combination thereof. Some implementations may optionally incorporate features such as error checking and correction (ECC) for data integrity, or security measures, such as encryption (e.g., WEP) and password protection.

In various embodiments, the computer system may include Internet of Things (IOT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

Various examples of modules may be implemented using circuitry, including various electronic hardware. By way of example and not limitation, the hardware may include transistors, resistors, capacitors, switches, integrated circuits, other modules, or some combination thereof. In various examples, the modules may include analog logic, digital logic, discrete components, traces and/or memory circuits fabricated on a silicon substrate including various integrated circuits (e.g., FPGAS, ASICs), or some combination thereof. In some embodiments, the module(s) may involve execution of preprogrammed instructions, software executed by a processor, or some combination thereof. For example, various modules may involve both hardware and software.

Claim adjustment processes may be error-prone and inconsistent because they rely on human interpretation of complex, unstructured policy language and claim details, which often include ambiguous terms and sector-specific provisions. The claim adjustment processes may, for example, create inefficiencies in detecting variances between initial coverage determinations and claim adjustment inputs. A CAPMS 100 may, for example, advantageously addresses this computing challenge by implementing a multi-engine architecture. A reference model interpretation engine 115 may, for example, advantageously be configured to apply an NLP model 265 to parse claim objects and reference model objects, extract named entities, and interpret coverage terms into structured outputs. The NLP model 265 may, for example, be configured to parse one or more claim adjustment inputs 130 to extract named entities and interpret the parameter sets of the one or more claim adjustment inputs 130 into structured outputs. The parameter sets of the one or more claim adjustment inputs 130 may, for example, include the provisions of the one or more claim adjustment inputs 130. A coverage comparison engine 135 may, for example, advantageously be configured to compare the initial coverage determination (ICD 120) with claim adjustment inputs using structured parameter sets and a standard terms interpretation dictionary to identify variances. A resolution flow generation engine 240 may, for example, automatically generate resolution templates and pre-filled forms based on detected variances, advantageously enabling accurate and efficient claim adjustment.

A historical claim analyzer 165 may, for example, advantageously ensure consistency, by performing similarity-based error detection by cross-referencing historical claim data to detect overlooked coverage or inconsistencies. The historical claim analyzer 165 may, for example, advantageously enhance scalability by reducing the need for manual review across large volumes of claims. By leveraging similarity-based error detection and cross-referencing historical claim data, the historical claim analyzer 165 may, for example, advantageously enable the CAPMS 100 to process thousands of claims in parallel without sacrificing accuracy. This automated comparison against prior decisions may, for example, advantageously ensure consistent interpretation across diverse policy types and sectors, allowing the CAPMS 100 to scale efficiently as claim volume grows.

As used herein, the term “reference model” may, for example, include a structured representation of coverage terms, provisions, and clauses, including an insurance policy or contract serving as the baseline for comparison. A “variance” or “discrepancy” may, for example, include a detected difference between the reference model and a claim adjustment input or interpretation. The term “error signal” (EOS) may, for example, include a system-generated indicator that flags potential misalignment, inconsistency, or error during coverage determination or claim adjustment processes. A “resolution object” or “resolution template” may, for example, include a predefined or dynamically generated construct that guides corrective actions, dispute flows, or remediation steps to reconcile variances and ensure compliance with the reference model.

In one embodiment, consider a policy clause stating: “Coverage for windstorm damage to residential property is limited to $50,000 per occurrence, subject to a $1,000 deductible, and excludes damage caused by flooding or earth movement.” A corresponding claim snippet may, for example, read: “Homeowner reports roof damage following a severe windstorm on Oct. 10, 2025, with estimated repair cost of $62,000.” The system may, for example, generate an Initial Coverage Determination (ICD) indicating windstorm coverage up to $49,000 after deductible, with exclusions confirmed as inapplicable. A variance may, for example, be detected when the Claim Adjustment Input (CAI) proposes $35,000 citing a “wear and tear” exclusion absent from the policy. Similarity Analysis Report (SAR 180) may, for example, be generated based on historical precedent for full windstorm coverage and may, for example, flag the discrepancy as likely human oversight. A resolution template may, for example, be produced, instructing the adjuster to align the payout with policy terms.

In some embodiments, the historical claim analyzer (HCA) implements an SBED pipeline to identify overlooked coverage or inconsistencies by comparing current claim interpretations against historical precedent. The pipeline may, for example, begin by vectorizing textual elements from the claim object, reference model, and historical claim data using an NLP-driven embedding model. These embeddings may, for example, capture semantic relationships between policy clauses, claim details, and prior decisions. Next, the system may, for example, compute similarity scores between the current claim and historical claims using distance metrics such as cosine similarity. A thresholding mechanism may, for example, then be applied to determine whether the similarity score exceeds a predefined confidence level, indicating that the historical claim is sufficiently comparable to warrant cross-reference. If the threshold is met, the system mat, for example, flag potential variances and generates a similarity analysis report (SAR 180) detailing omitted items and recommending corrective actions. This pipeline may, for example, advantageously ensures accurate detection of discrepancies and supports automated resolution workflows.

In some embodiments, the SBED pipeline may, for example, begins with a vectorization stage, where textual elements from the claim object, reference model, and historical claim data are converted into high-dimensional numerical representations. This process may, for example, leverage NLP models (e.g., BERT or GPT embeddings) to capture semantic meaning beyond simple keyword matching. By encoding clauses, coverage terms, and claim details into dense vectors, the system may, for example, advantageously enable robust similarity comparisons that account for linguistic nuances and contextual relationships between policy language and claim interpretations.

Following vectorization, the SBED pipeline may, for example, include similarity computation to measure the degree of alignment between the current claim and historical claims. In some implementations, cosine similarity or other distance metrics may, for example, be applied to the generate embeddings to produce a similarity score. This score may, for example, reflect how closely the current claim's coverage scenario and associated parameters match prior claims under comparable policy language. By quantifying semantic proximity, the system may, for example, advantageously identify historical precedents that may inform coverage determinations and highlight potential discrepancies in the claim adjustment process.

The SBED pipeline may, for example, include thresholding, such that the computed similarity scores may, for example, be evaluated against a predefined confidence threshold. If the similarity score exceeds the threshold, the system classifies the historical claim as relevant and triggers further analysis. The classification of a historical claim as relevant may, for example, include generating a Similarity Analysis Report (SAR 180) that lists omitted items, relevance indicators, and recommendations for corrective action. Thresholding may, for example, advantageously ensure that highly comparable historical claims influence variance detection, reducing false positives and improving the accuracy of automated resolution workflows.

In some aspects, the techniques described herein relate to a system including: a data store including a program of instructions (e.g., data store 250, program of instructions stored in memory module 230 or storage module 235); and, a processor operably coupled to the data store (e.g., processor 205 operably coupled to data store 250) such that, when the processor executes the program of instructions, the processor causes operations to be performed to automatically detect variances between one or more state model vectors (e.g., initial coverage determination 120) and one or more input parameter vectors (e.g., claim adjustment inputs 130) and generate one or more resolution sequences (e.g., coverage analysis object 145, resolution object 150b) based on a plurality of historical data stores (e.g., historical claim analyzer 165, historical data stores containing prior claims and reference model analyses) and analyzed claim data (e.g., claim object 105) and reference model data structures (e.g., reference model 110), the operations including: receive one or more claim objects including claim data (e.g., claim object 105); receive one or more reference model objects including reference model data structures (e.g., reference model 110); apply a natural language processing model (e.g., NLP model 265) to the one or more claim objects and one or more reference model objects to analyze the claim data and reference model data structures and generate an initial coverage determination (e.g., initial coverage determination 120); receive one or more claim adjustment inputs including one or more parameter sets (e.g., claim adjustment input 130); identify one or more variances between the initial coverage determination and the one or more claim adjustment inputs by comparing the initial coverage determination to the one or more parameter sets; automatically cross-reference the identified one or more variances with a plurality of historical data stores, the historical data stores including historical claim data (e.g., historical claim analyzer 165, historical claim data), to determine a result, the result including a determination of whether the historical claim data includes one or more parallel variances parallelled to the identified one or more variances; determine whether the one or more claim adjustment inputs includes one or more errors based on the identified one or more variances and the result (e.g., identified potential errors IPE 150a); upon determining whether one or more errors is present in the one or more claim adjustment inputs, automatically generate an error signal and automatically transmit the error signal to a user device (e.g., error and omission signal EOS 150c transmitted to user device 215); automatically generate a coverage analysis object (e.g., coverage analysis object CAO 145); and, transmit the coverage analysis object to one or more user devices (e.g., CAO 145 transmitted to user device 215).

In some aspects, the techniques described herein relate to a system, wherein the claim data further includes claim records corresponding to an incident, the claim records including data related to the incident (e.g., claim records in claim object 105, incident data).

In some aspects, the techniques described herein relate to a system, wherein the reference model data structures further include identifiers, reference model numbers, coverage terms, deductibles, coverage limits, and reference model terms (e.g., reference model 110, identifiers, coverage terms, deductibles, limits).

In some aspects, the techniques described herein relate to a system, wherein the coverage analysis object further includes pre-filled claim forms (e.g., pre-filled claim forms in CAO 145).

In some aspects, the techniques described herein relate to a system, wherein the coverage analysis object further includes one or more pre-filled resolution templates including predefined instruction sets to communicate the one or more errors (e.g., resolution templates from resolution template datastore 160, predefined instruction sets).

In some aspects, the techniques described herein relate to a system, wherein the one or more parameter sets further includes coverage limits, deductibles, and conditions (e.g., parameter sets in claim adjustment input 130).

In some aspects, the techniques described herein relate to a system, wherein the initial coverage determination further includes: structured outputs including coverage scenarios, estimated coverage amounts, and ambiguous and complex reference model parameter sets (e.g., ICD 120: coverage scenarios 125a, coverage amount 125b, exclusions 125c, warnings 125d).

In some aspects, the techniques described herein relate to a system, wherein the historical claim data further includes: prior claims, reference model analyses and resolution results (e.g., historical claim analyzer 165, historical claim data).

In some aspects, the techniques described herein relate to a system, wherein the coverage analysis object further includes one or more resolution objects, one or more identified potential errors, and one or more coverage reports (e.g., CAO 145: resolution object 150b, identified potential errors 150a, coverage report 150d).

In some aspects, the techniques described herein relate to a system, wherein the operations further include: automatically transmit the coverage analysis object to an external entity (e.g., external entities 220); monitor for a response from the external entity, the response including a secondary one or more claim adjustment inputs including secondary one or more parameters sets; determine whether the response has been received from the external entity (e.g., user support engine 245); upon reception adjustment inputs by comparing the initial coverage determination to the secondary one or more parameter sets (e.g., coverage comparison engine 135); automatically cross-reference the identified one or more variances with a plurality data, to determine a result, the result including a determination data includes one or more parallel variances parallelled to the identified one or more variances; determine whether the secondary one or more claim adjustment inputs includes one or more errors based on the identified one or more variances and the result (e.g., error and omission signal EOS 150c, identified potential errors IPE 150a); upon determining whether one or more errors is present in the one or more claim adjustment inputs, automatically generate an error signal and automatically transmit the error signal to a user device (e.g., error and omission signal EOS 150c transmitted to user device 215); automatically generate a coverage analysis object including one or more resolution objects, one or more identified potential errors, and one or more coverage reports (e.g., CAO 145: resolution object 150b, identified potential errors 150a, coverage report 150d); and, transmit the coverage analysis object to one or more user devices (e.g., CAO 145 transmitted to user device 215).

In some aspects, the techniques described herein relate to a computer program product including a program of instructions tangibly embodied on a non-transitory computer readable medium wherein when the instructions are executed on a processor, the processor causes operations to be performed to automatically detect variances between one or more state model vectors (e.g., initial coverage determination 120) and one or more input parameter vectors (e.g., claim adjustment inputs 130) and generate one or more resolution sequences (e.g., coverage analysis object 145, resolution object 150b) based on a plurality of historical data stores (e.g., historical claim analyzer 165, historical data stores containing prior claims and reference model analyses) and analyzed claim data (e.g., claim object 105) and reference model data structures (e.g., reference model 110), the operations including: receive one or more claim objects including claim data (e.g., claim object 105); receive one or more reference model objects including reference model data structures (e.g., reference model 110); apply a natural language processing model (e.g., NLP model 265) to the one or more claim objects and one or more reference model objects to analyze the claim data and reference model data structures and generate an initial coverage determination (e.g., reference model interpretation engine 115, initial coverage determination 120); receive one or more claim adjustment inputs including one or more parameter sets (e.g., claim adjustment input 130); identify one or more variances between the initial coverage determination and the one or more claim adjustment inputs by comparing the initial coverage determination to the one or more parameter sets (e.g., coverage comparison engine 135, variance identification); determine whether the one or more claim adjustment inputs includes one or more errors based on the identified one or more variances (e.g., error and omission signal EOS 150c, identified potential errors IPE 150a); upon determining whether one or more errors is present in the one or more claim adjustment inputs, automatically generate an error signal and automatically transmit the error signal to a user device (e.g., error and omission signal EOS 150c transmitted to user device 215); automatically generate a coverage analysis object (e.g., coverage analysis object CAO 145); and, transmit the coverage analysis object to one or more user devices (e.g., CAO 145 transmitted to user device 215).

In some aspects, the techniques described herein relate to a computer program product, wherein the claim data further includes claim records corresponding to an incident, the claim records including data related to the incident (e.g., claim records in claim object 105, incident data).

In some aspects, the techniques described herein relate to a computer program product, wherein the reference model data structures further include identifiers, reference model numbers, coverage terms, deductibles, coverage limits, and reference model terms (e.g., reference model 110, identifiers, coverage terms, deductibles, limits).

In some aspects, the techniques described herein relate to a computer program product, wherein the operations further include: vectorize textual elements object, reference model, and historical claim data into semantic embeddings using a natural language processing model (e.g., NLP model 265); compute similarity scores between the claim object and historical claim data using a distance metric (e.g., similarity analysis report SAR 180); apply a thresholding mechanism to determine whether the similarity score exceeds a predefined confidence level (historical claim analyzer 165); upon determining that the threshold is met, identify one or more variances between the initial coverage determination and historical precedent (e.g., coverage comparison engine 135); generate a similarity analysis report including omitted items and recommended corrective actions (e.g., similarity analysis report SAR 180); and, transmit the similarity analysis report to a user device (e.g., user device 215).

In some aspects, the techniques described herein relate to a computer program product, wherein the one or more resolution objects further includes one or more pre-filled resolution templates including predefined instruction sets to communicate the one or more errors (e.g., resolution templates from resolution template datastore 160, predefined instruction sets).

In some aspects, the techniques described herein relate to a computer program product, wherein the coverage analysis object further includes one or more resolution objects, one or more identified potential errors, and one or more coverage reports (e.g., CAO 145: resolution object 150b, identified potential errors 150a, coverage report 150d).

In some aspects, the techniques described herein relate to a computer program product, wherein the initial coverage determination further includes: structured outputs including coverage scenarios, estimated coverage amounts, and ambiguous and complex reference model parameter sets (e.g., ICD 120: coverage scenarios 125a, coverage amount 125b, exclusions 125c, warnings 125d).

In some aspects, the techniques described herein relate to a computer program product, wherein the one or more parameter sets further include: coverage limits, deductibles, and conditions (e.g., parameter sets in claim adjustment input 130).

In some aspects, the techniques described herein relate to a computer program product, wherein the error signal further includes an error and omission signal including a natural language output of the one or more variances (e.g., error and omission signal EOS 150c).

In some aspects, the techniques described herein relate to a computer program product, wherein the operations further include: automatically transmit the coverage analysis object to an external entity (e.g., external entities 220); monitor for a response from the external entity, the response including a secondary one or more claim adjustment inputs including secondary one or more parameters sets (e.g., secondary claim adjustment inputs); determine whether the response has been received from the external entity (e.g., user support engine 245); upon reception adjustment inputs to extract and analyze the secondary one or more parameter sets (e.g., coverage comparison engine 135); identify one or more variances between the initial coverage determination and the secondary one or more claim adjustment inputs by comparing the initial coverage determination to the secondary one or more parameter sets (e.g., coverage comparison engine 135); automatically cross-reference the identified one or more variances with a plurality data, to determine a result, the result including a determination data includes one or more parallel variances parallelled to the identified one or more variances (e.g., similarity analysis report SAR 180); determine whether the secondary one or more claim adjustment inputs includes one or more errors based on the identified one or more variances and the result (e.g., error and omission signal EOS 150c, identified potential errors IPE 150a); upon determining whether one or more errors is present in the one or more claim adjustment inputs, automatically generate an error signal and automatically transmit the error signal to a user device (e.g., error and omission signal EOS 150c transmitted to user device 215); automatically generate a coverage analysis object including one or more resolution objects, one or more identified potential errors, and one or more coverage reports (e.g., CAO 145: resolution object 150b, identified potential errors 150a, coverage report 150d); and, transmit the coverage analysis object to one or more user devices (e.g., CAO 145 transmitted to user device 215).

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A system comprising:
a data store comprising a program of instructions; and,
a processor operably coupled to the data store such that, when the processor executes the program of instructions, the processor causes operations to be performed to automatically detect variances between one or more state model vectors and one or more input parameter vectors and generate one or more resolution sequences based on a plurality of historical data stores and analyzed claim data and reference model data structures, the operations comprising:
receive one or more claim objects comprising claim data;
receive one or more reference model objects comprising reference model data structures;
apply a natural language processing model to the one or more claim objects and one or more reference model objects to analyze the claim data and reference model data structures and generate an initial coverage determination;
receive one or more claim adjustment inputs comprising one or more parameter sets;
identify one or more variances between the initial coverage determination and the one or more claim adjustment inputs by comparing the initial coverage determination to the one or more parameter sets;
automatically cross-reference the identified one or more variances with a plurality of historical data stores, the historical data stores comprising historical claim data, to determine a result, the result comprising a determination of whether the historical claim data includes one or more parallel variances parallelled to the identified one or more variances;
determine whether the one or more claim adjustment inputs includes one or more errors based on the identified one or more variances and the result;
upon determining whether one or more errors is present in the one or more claim adjustment inputs, automatically generate an error signal and automatically transmit the error signal to a user device;
automatically generate a coverage analysis object; and,
transmit the coverage analysis object to one or more user devices.

2. The system of claim 1, wherein the claim data further comprises claim records corresponding to an incident, the claim records comprising data related to the incident.

3. The system of claim 1, wherein the reference model data structures further comprise identifiers, reference model numbers, coverage terms, deductibles, coverage limits, and reference model terms.

4. The system of claim 1, wherein the coverage analysis object further comprises pre-filled claim forms.

5. The system of claim 1, wherein the coverage analysis object further comprises one or more pre-filled resolution templates comprising predefined instruction sets to communicate the one or more errors.

6. The system of claim 1, wherein the one or more parameter sets further comprises coverage limits, deductibles, and conditions.

7. The system of claim 1, wherein the initial coverage determination further comprises: structured outputs comprising coverage scenarios, estimated coverage amounts, and ambiguous and complex reference model parameter sets.

8. The system of claim 1, wherein the historical claim data further comprises: prior claims, reference model analyses and resolution results.

9. The system of claim 1, wherein the coverage analysis object further comprises one or more resolution objects, one or more identified potential errors, and one or more coverage reports.

10. The system of claim 1, wherein the operations further comprise:
automatically transmit the coverage analysis object to an external entity;
monitor for a response from the external entity, the response comprising a secondary one or more claim adjustment inputs comprising secondary one or more parameters sets;
determine whether the response has been received from the external entity;
upon reception of the response from the external entity, automatically transmit the response to the user device;
identify one or more variances between the initial coverage determination and the secondary one or more claim adjustment inputs by comparing the initial coverage determination to the secondary one or more parameter sets;
automatically cross-reference the identified one or more variances with a plurality of historical data stores, the historical data stores comprising historical claim data, to determine a result, the result comprising a determination of whether the historical claim data includes one or more parallel variances parallelled to the identified one or more variances;
determine whether the secondary one or more claim adjustment inputs includes one or more errors based on the identified one or more variances and the result;
upon determining whether one or more errors is present in the one or more claim adjustment inputs, automatically generate an error signal and automatically transmit the error signal to a user device;
automatically generate a coverage analysis object comprising one or more resolution objects, one or more identified potential errors, and one or more coverage reports; and,
transmit the coverage analysis object to one or more user devices.

11. A computer program product comprising a program of instructions tangibly embodied on a non-transitory computer readable medium wherein when the instructions are executed on a processor, the processor causes operations to be performed to automatically detect variances between one or more state model vectors and one or more input parameter vectors and generate one or more resolution sequences based on a plurality of historical data stores and analyzed claim data and reference model data structures, the operations comprising:
receive one or more claim objects comprising claim data;
receive one or more reference model objects comprising reference model data structures;
apply a natural language processing model to the one or more claim objects and one or more reference model objects to analyze the claim data and reference model data structures and generate an initial coverage determination;
receive one or more claim adjustment inputs comprising one or more parameter sets;
identify one or more variances between the initial coverage determination and the one or more claim adjustment inputs by comparing the initial coverage determination to the one or more parameter sets;
determine whether the one or more claim adjustment inputs includes one or more errors based on the identified one or more variances;
upon determining whether one or more errors is present in the one or more claim adjustment inputs, automatically generate an error signal and automatically transmit the error signal to a user device;
automatically generate a coverage analysis object; and,
transmit the coverage analysis object to one or more user devices.

12. The computer program product of claim 11, wherein the claim data further comprises claim records corresponding to an incident, the claim records comprising data related to the incident.

13. The computer program product of claim 11, wherein the reference model data structures further comprise identifiers, reference model numbers, coverage terms, deductibles, coverage limits, and reference model terms.

14. The computer program product of claim 11, wherein the operations further comprise:
vectorize textual elements of the claim object, reference model, and historical claim data into semantic embeddings using a natural language processing model;
compute similarity scores between the claim object and historical claim data using a distance metric;
apply a thresholding mechanism to determine whether the similarity score exceeds a predefined confidence level;
upon determining that the threshold is met, identify one or more variances between the initial coverage determination and historical precedent;
generate a similarity analysis report comprising omitted items and recommended corrective actions; and,
transmit the similarity analysis report to a user device.

15. The computer program product of claim 11, wherein the one or more resolution objects further comprises one or more pre-filled resolution templates comprising predefined instruction sets to communicate the one or more errors.

16. The computer program product of claim 11, wherein the coverage analysis object further comprises one or more resolution objects, one or more identified potential errors, and one or more coverage reports.

17. The computer program product of claim 11, wherein the initial coverage determination further comprises: structured outputs comprising coverage scenarios, estimated coverage amounts, and ambiguous and complex reference model parameter sets.

18. The computer program product of claim 11, wherein the one or more parameter sets further comprise: coverage limits, deductibles, and conditions.

19. The computer program product of claim 11, wherein the error signal further comprises an error and omission signal comprising a natural language output of the one or more variances.

20. The computer program product of claim 11, wherein the operations further comprise:
automatically transmit the coverage analysis object to an external entity;
monitor for a response from the external entity, the response comprising a secondary one or more claim adjustment inputs comprising secondary one or more parameters sets;
determine whether the response has been received from the external entity;
upon reception of the response from the external entity, automatically transmit the response to the user device;
apply the natural language processing model to the one or more secondary claim adjustment inputs to extract and analyze the secondary one or more parameter sets;
identify one or more variances between the initial coverage determination and the secondary one or more claim adjustment inputs by comparing the initial coverage determination to the secondary one or more parameter sets;
automatically cross-reference the identified one or more variances with a plurality of historical data stores, the historical data stores comprising historical claim data, to determine a result, the result comprising a determination of whether the historical claim data includes one or more parallel variances parallelled to the identified one or more variances;
determine whether the secondary one or more claim adjustment inputs includes one or more errors based on the identified one or more variances and the result;
upon determining whether one or more errors is present in the one or more claim adjustment inputs, automatically generate an error signal and automatically transmit the error signal to a user device;
automatically generate a coverage analysis object comprising one or more resolution objects, one or more identified potential errors, and one or more coverage reports; and,
transmit the coverage analysis object to one or more user devices.
